(19) United States
(12) Patent Application Publication
(10) Pub. No.: US 2017/0261795 A1
(43) Pub. Date: Sep. 14, 2017

(54) METHOD FOR MANUFACTURING LIQUID CRYSTAL DISPLAY PANEL

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Junxiao Zhang, Shenzhen, Guangdong (CN); De Jiun Li, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/778,248

(22) PCT Filed: Jul. 2, 2015
(86) PCT No.: PCT/CN2015/083136

§ 371 Date: Dec. 1, 2016

(30) Foreign Application Priority Data
Jun. 24, 2015 (CN) 201510351119.8

(51) Int. Cl. G02F 1/1339; G02F 1/1335; G02F 1/1337; G02F 1/1368

(52) U.S. Cl. CPC G02F 1/13394; G02F 1/1368; G02F 1/133514; G02F 1/133512; G02F 1/1337; G02F 2001/13396; G02F 2001/13398

(57) ABSTRACT

Disclosed is a method for manufacturing a liquid crystal display panel. The method includes two steps. In step 1, before being pressed together, the first substrate and the second substrate are provided therebetween with a first photo spacer having a relatively high height and a second photo spacer having a relatively low height, which is the same as a thickness of the liquid crystal layer. In step 2, after the first substrate and the second substrate are pressed together, the first photo spacer and the second photo spacer each have a thickness being the same as the thickness of the liquid crystal layer. The method is able to reduce the thickness of an air layer caused by the inconsistency between the height of the photo spacer and the thickness of the liquid crystal layer when a liquid crystal cell is formed, thereby improving the display quality of the liquid crystal device.

### CROSS REFERENCE TO RELATED APPLICATIONS

The present application claims the priority of Chinese patent application CN201510351119.8, entitled “Method for manufacturing liquid crystal display panel” and filed on Jun. 24, 2015, the entirety of which is incorporated herein by reference.

### TECHNICAL FIELD

The present disclosure relates to the technical field of liquid crystal display, and in particular, to a method for manufacturing a liquid crystal display panel.

### TECHNICAL BACKGROUND

In the processes of manufacturing liquid crystal display devices, there is a process of arranging color filter modules (i.e., three-primary-color filters, namely red, green, and blue color filters) on an array substrate, i.e., arranging color filters on an array substrate, which is known globally as color filter on array (COA). In this COA process, the liquid crystal panel as obtained comprises a first substrate, a second substrate, and a liquid crystal layer sandwiched between the first substrate and the second substrate. The first substrate is provided, from inside to outside, on a side thereof facing the liquid crystal layer, with a thin film transistor (TFT) array and color filter modules corresponding to the thin film transistor array. The second substrate is provided with a black matrix on a side thereof facing the liquid crystal layer for preventing light leakage. Besides, the first substrate and the second substrate are provided respectively with an alignment film at an outermost part of the side thereof facing the liquid crystal layer, for determining a pretilt angle of liquid crystals in the liquid crystal layer.

In the existing technologies, in the process of forming the liquid crystal cell, a photo spacer with a height slightly larger than the thickness of the cell is usually provided at the edge of pixels on a side of the second substrate, so as to keep a distance between the first substrate and the second substrate. After dropping the liquid crystals, the first substrate and the second substrate are pressed together. This pressing step enables the photo spacer to be compressed to a certain degree. When the height of the compressed photo spacer is larger than the thickness of the liquid crystal layer, an air layer with certain thickness is generated between the surface of the liquid crystal layer and the substrate. The air layer will influence the optical index of the liquid crystal display device.

### SUMMARY OF THE INVENTION

The objective of the present disclosure is to reduce the thickness of the air layer between the liquid crystal layer and the substrate in the existing technologies, so as to greatly improve the optical index of liquid crystal display devices.

The present disclosure provides a method for manufacturing a liquid crystal display panel. The liquid crystal display panel comprises a first substrate, a second substrate, and a liquid crystal layer sandwiched between the first substrate and the second substrate. The first substrate is provided, from inside to outside, on a side thereof facing the liquid crystal layer, with a thin film transistor (TFT) array and color filter modules corresponding to the thin film transistor array. The method comprises two steps. In step 1, before being pressed together, the first substrate and the second substrate are provided therebetween with a first photo spacer having a relatively high height and a second photo spacer having a relatively low height, which is the same as a thickness of the liquid crystal layer. In step 2, after the first substrate and the second substrate are pressed together, the first photo spacer and the second photo spacer each have a height being the same as the thickness of the liquid crystal layer. By providing the first photo spacer and the second photo spacer with different heights, and further enabling the first photo spacer and the second photo spacer to have a height being the same as the thickness of the liquid crystal layer after they are compressed, the air layer generated due to the inconsistency between the height of the photo spacer and the thickness of the liquid crystal layer when the liquid crystal cell is formed will be reduced, thereby improving the display quality of the liquid crystal display device.

Preferably, the first photo spacer or the second photo spacer is arranged in a color hole between neighboring color filter modules. With such arrangement, the photo spacer(s) will not affect the display effect (e.g., color and gray scale) of the display area of the liquid crystal panel.

Preferably, the first photo spacer or the second photo spacer is arranged in a contact hole of an integrated circuit of the first substrate. In this case, the hollow space within the contact hole can be used effectively, and the photo spacer will not influence the wiring of the circuits and the distribution of electric field.

Preferably, the first substrate is photoetched with a photomask for photo spacer, so as to form the first photo spacer and the second photo spacer, and patterns of the photomask for photo spacer have three levels of tones, i.e., full tone, half tone, and zero tone. Thus, being different from existing technologies, according to the method for manufacturing liquid crystal display panel provided by the present disclosure, the first photo spacer and the second photo spacer are formed on the first substrate, rather than on the second substrate, which enormously decreases the difficultly in manufacturing the liquid crystal panel since it is not necessary to photo-etch the second substrate.

Preferably, when the first photo spacer and the second photo spacer are formed by negative photoetching, the full tone level of the photomask for photo spacer corresponds to the first photo spacer on the first substrate, the half tone level of the photomask for photo spacer corresponds to the second photo spacer on the first substrate, and the zero tone level of the photomask for photo spacer corresponds to a region of the first substrate where none of the first photo spacer and the second photo spacer is provided.

Preferably, the full tone level of the photomask of photo spacer is structured as a first photomask hole, and the half tone level of the photomask for photo spacer is structured as a second photomask hole. The first photomask hole is larger than the second photomask hole. Such arrangement enables the first photo spacer to have a relative higher height or a relatively larger cross-sectional area than the second photo spacer.

Preferably, before the first substrate and the second substrate are pressed together, the height of the first photo spacer is within a range from 3 μm to 3.4 μm, and the height of the second photo spacer is within a range from 2.4 μm to 2.8 μm.

Preferably, before the first substrate and the second substrate are pressed together, the height of the first photo spacer is 3.2 μm, and the height of the second photo spacer is 2.6 μm.

Preferably, the second substrate is provided with a black matrix on a side thereof facing the liquid crystal layer for preventing light leakage of the liquid crystal display panel, so as to ensure a good display effect.

Preferably, the first substrate and the second substrate are provided respectively with an alignment film at an outermost part of the side facing the liquid crystal layer. The alignment film can determine a pretilt angle of liquid crystal in the liquid crystal layer.

The method provided by the present disclosure achieves the following notable progress.

On the one hand, according to the present disclosure, photo spacers with different heights are provided, and after being compressed, the photo spacers are able to have a height equal to the thickness of the liquid crystal layer, thus reducing the thickness of the air layer between the liquid crystal layer and the substrate, and finally improving the optical index of the liquid crystal display device greatly.

On the other hand, according to the present disclosure, the photo spacers are arranged in color holes between neighboring color filter modules, or in the contact holes of the integrated circuit of the first substrate, which reduces the difficultly of the manufacturing process. And it is not necessary to photo-etch the second substrate.

The above technical features can be combined with one another in various appropriate ways or substituted by technical features of equivalent technical effects, as long as the objective of the present disclosure can be achieved.

### BRIEF DESCRIPTION OF THE DRAWINGS

A detailed description will be given below on the present disclosure based on the embodiments and with reference to the accompanying drawings.

FIG. 1 shows step 1 of a method for manufacturing liquid crystal display panel according to the present disclosure; and

FIG. 2 shows step 2 of the method for manufacturing liquid crystal display panel according to the present disclosure.

In the drawings, the same components are indicated by the same reference signs. The drawings are not drawn to scale.

### DETAILED DESCRIPTION OF THE EMBODIMENTS

The present disclosure will be explained below in detail with reference to the accompanying drawings.

The present disclosure provides a method for manufacturing a liquid crystal display panel.

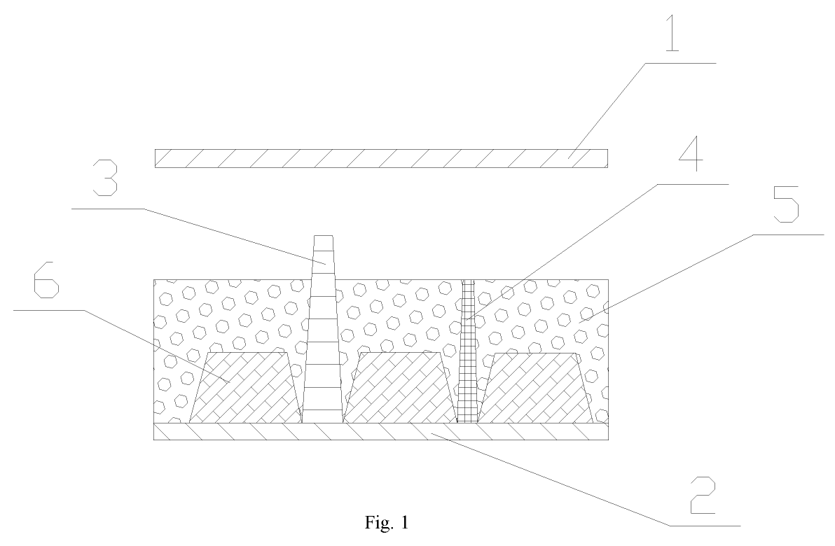

The method provided by the present disclosure is based on the color filter on array (COA) process. As shown in FIG. 1, in the COA process, the liquid crystal panel as obtained comprises a first substrate 2, a second substrate 1, and a liquid crystal layer 5 sandwiched between the first substrate 2 and the second substrate 1. The first substrate 2 is provided, from inside to outside, on a side thereof facing the liquid crystal layer 5, with a thin film transistor (TFT) array (not shown in the drawing) and color filter modules 6 corresponding to the TFT array. The color filter modules 6 are three-primary-color filters, namely red, green, and blue color filters. Each of the color filter modules 6 is a color filter of one of the three-primary colors, and corresponds to a sub-pixel in the TFT array. The color filters of the three different colors are arranged alternatively, so as to control, together with the deflected liquid crystals, the color of the finally displayed image. In addition, the second substrate 1 is provided with a black matrix on a side thereof facing the liquid crystal layer 5 for preventing light leakage. The first substrate 2 and the second substrate 1 are provided respectively with an alignment film at an outermost part of the side thereof facing the liquid crystal layer 5, for determining a pretilt angle of the liquid crystals in the liquid crystal layer 5.

The method for manufacturing liquid crystal display panel provided in the present disclosure comprises at least two steps.

FIG. 1 shows step 1 of the method for manufacturing liquid crystal display panel according to the present disclosure. As shown in FIG. 1, in step 1, before being pressed together, the first substrate 2 and the second substrate 1 are provided therebetween with a main photo spacer 3 having a relatively high height (also called as the first photo spacer in the present disclosure) and a sub photo spacer 4 having a relatively low height (also called as the second photo spacer in the present disclosure). The sub photo spacer 4 has a height being the same as a thickness of the liquid crystal layer.

The photo spacers can be formed according to the following methods. The first substrate 2 is photoetched with a photomask for photo spacer, so as to form the main photo spacer 3 and the sub photo spacer 4. In the photoetching process, a half tone photomask is used to obtain photo spacers with different heights. Specifically, in the photoetching process using a half tone photomask, patterns of the photomask for photo spacer have three levels of tones, i.e., full tone, half tone, and zero tone. In the process of producing the main photo spacer 3 and the sub photo spacer 4 by negative photoetching, the full tone level of the half tone photomask for photo spacer corresponds to the main photo spacer 3 on the first substrate 2, the half tone level of the half tone photomask for photo spacer corresponds to the sub photo spacer 4 on the first substrate 2, and the zero tone level of the half tone photomask for photo spacer corresponds to a region of the first substrate 2 where none of the main photo spacer 3 and the sub photo spacer 4 is provided. In the negative photoetching process, light completely passes through the full tone level of the photomask for photo spacer, retaining almost an entire layer to be etched on the first substrate 2 which corresponds to the full tone level, and thus forming the main photo spacer 3 having a relatively high height. The light passes partially through the half tone level of the photomask for photo spacer, etching the layer to be etched on the first substrate 2 which corresponds to the half tone level on certain scale, and forming the sub photo spacer 4 having a relatively low height. No light passes through the zero tone level of the photomask for photo spacer, etching away almost all the layer to be etched on the first substrate 2 which corresponds to the zero tone level, and thus forming the region of the first substrate 2 where none of the main photo spacer 3 and the sub photo spacer 4 is provided, i.e., the plain part.

In addition, photo spacers with two different heights and/or cross-sectional areas can be formed by two photomask holes of different sizes on the half tone photomask for photo spacer. Specifically, the full tone level of the half tone photomask for photo spacer is structured as a first photomask hole, and the half tone level of the half tone photomask for photo spacer is structured as a second photomask hole. The first photomask hole is larger than the second photomask hole. In this way, the main photo spacer 3 formed by the half tone photoetching process has a relatively larger height and a relatively larger cross-sectional area, and the sub photo spacer 4 formed by the half tone photoetching process has a relatively smaller height and a relatively smaller cross-sectional area.

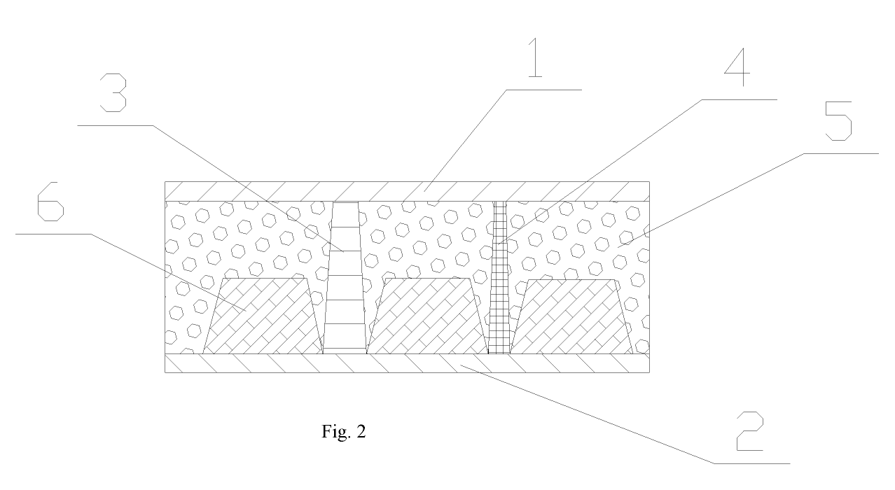

The present disclosure provides the following preferable technical solutions about features of the main photo spacer 3 and the sub photo spacer 4. As far as positions are concerned, as shown in FIGS. 1 and 2, the main photo spacer 3 or the sub photo spacer 4 can be arranged in color holes between neighboring color filter modules 6. Or, in an alternative technical solution, the main photo spacer 3 or the sub photo spacer 4 can be arranged in contact holes of the integrated circuit of the first substrate 2.

As far as heights are concerned, the heights of the main photo spacer 3 and the sub photo spacer 4 should meet the following requirements. Before the first substrate 2 and the second substrate 1 are pressed together, the height of the main photo spacer 3 can be selected within a range from 3 μm to 3.4 μm, and the height of the sub photo spacer 4 can be selected within a range from 2.4 μm to 2.8 μm. Preferably, before the first substrate 2 and the second substrate 1 are pressed together, the height of the main photo spacer 3 can be 3.2 μm, and the height of the sub photo spacer 4 can be 2.6 μm, which is substantially equivalent to the thickness of the liquid crystal layer 5).

The method for manufacturing liquid crystal display panel provided by the present disclosure comprises further step 2. FIG. 2 shows step 2 of the method for manufacturing liquid crystal display panel according to the present disclosure.

As shown in FIG. 2, when the first substrate 2 and the second substrate 1 are pressed together, the taller main photo spacer 3 is compressed to have a height being the same as that of the sub photo spacer 4. Meanwhile, the heights of both of the main photo spacer 3 and the sub photo spacer 4 are the same as the thickness of the liquid crystal layer 5.

According to the method for manufacturing liquid crystal display panel provided by the present disclosure, on the one hand, a main photo spacer 3 and a sub photo spacer 4 with different heights are provided, and they are able to have a height equal to the thickness of the liquid crystal layer 5 after being compressed, thereby reducing the thickness of the air layer produced by the inconsistency between the height of the photo spacer and the thickness of the liquid crystal layer when forming the liquid crystal cell, and finally improving the display quality of the liquid crystal display device. On the other hand, different from the existing technologies, the main photo spacer 3 and the sub photo spacer 4 in the present disclosure are formed for example, by photoetching, on the first substrate 2, rather than on the second substrate 1, which enormously decreases the difficultly in manufacturing the liquid crystal panel because it is not necessary to photo-etch the second substrate 2.

The embodiments provided herein serve merely as examples in illustrating the present disclosure with respect to the principles and implementing methods thereof. Any amendments or arrangements that can be readily envisioned by those skilled in the art are intended to be within the scope of the present disclosure. Any variations different from those in the original claims can be combined together with technical features described in the dependent claims and description of the present disclosure, and technical features based on a single embodiment can be applied to other embodiments in the present disclosure.

1. A method for manufacturing a liquid crystal display panel, which comprises a first substrate, a second substrate, and a liquid crystal layer sandwiched between the first substrate and the second substrate, the first substrate being provided, from inside to outside, on a side thereof facing the liquid crystal layer, with a thin film transistor array and color filter modules corresponding to the thin film transistor array,
wherein the method comprises two steps:
step 1, providing, before the first substrate and the second substrate being pressed together, the first substrate and the second substrate therebetween with a first photo spacer having a relatively high height and a second photo spacer having a relatively low height, which is the same as a thickness of the liquid crystal layer, and
step 2, pressing the first substrate and the second substrate together, enabling the first photo spacer and the second photo spacer each to have a height being the same as the thickness of the liquid crystal layer.

2. The method according to claim 1, wherein the first photo spacer or the second photo spacer is arranged in a color hole between neighboring color filter modules.

3. The method according to claim 1, wherein the first photo spacer or the second photo spacer is arranged in a contact hole of an integrated circuit of the first substrate.

4. The method according to claim 1, wherein the first substrate is photoetched with a photomask for photo spacer, so as to form the first photo spacer and the second photo spacer, and patterns of the photomask for photo spacer have three levels of tones, i.e., full tone, half tone, and zero tone.

5. The method according to claim 4, wherein the first photo spacer and the second photo spacer are formed by negative photoetching, and
wherein the full tone level of the photomask for photo spacer corresponds to the first photo spacer on the first substrate, the half tone level of the photomask for photo spacer corresponds to the second photo spacer on the first substrate, and the zero tone level of the photomask for photo spacer corresponds to a region of the first substrate where none of the first photo spacer and the second photo spacer is provided.

6. The method according to claim 5, wherein the full tone level of the photomask for photo spacer is structured as a first photomask hole, and the half tone level of the photomask for photo spacer is structured as a second photomask hole, the first photomask hole being larger than the second photomask hole.

7. The method according to any of the claims 1 to 6, wherein before the first substrate and the second substrate are pressed together, the height of the first photo spacer is within a range from 3 μm to 3.4 μm, and the height of the second photo spacer is within a range from 2.4 μm to 2.8 μm.

8. The method according to claim 7, wherein before the first substrate and the second substrate are pressed together, the height of the first photo spacer is 3.2 μm, and the height of the second photo spacer is 2.6 μm.

9. The method according to claim 1, wherein the second substrate is provided with a black matrix on a side thereof facing the liquid crystal layer.

10. The method according to claim 7, wherein the second substrate is provided with a black matrix on a side thereof facing the liquid crystal layer.

11. The method according to claim 1, wherein the first substrate and the second substrate are provided respectively with an alignment film at an outermost part of the side thereof facing the liquid crystal layer.

12. The method according to claim 7, wherein the first substrate and the second substrate are provided respectively with an alignment film at the outermost part of the side thereof facing the liquid crystal layer.
